(19) United States
(12) Patent Application Publication
(10) Pub. No.: US 2024/0285377 A1
(43) Pub. Date: Aug. 29, 2024

(54) Implant and preparation method thereof

(71) Applicant: Gaofeng Medical Equipment (Wuxi) Co., Ltd, Jiangsu (CN)

(72) Inventors: Jun GAO, Jiangsu (CN); Xingrong GAO, Jiangsu (CN); Yaxing BAO, Jiangsu (CN)

(21) Appl. No.: 18/547,271

(22) PCT Filed: Jul. 27, 2023
(86) PCT No.: PCT/CN2023/109624

§ 371 Date: Aug. 21, 2023

(30) Foreign Application Priority Data
Jun. 7, 2022 (CN) 2022106364294

(51) Int. Cl. A61C 8/00

(52) U.S. Cl. CPC A61C 8/0025; A61C 8/0054; A61C 2008/0046

(57) ABSTRACT

An implant and preparation method thereof, wherein the implant comprises an implant body, the implant body comprises an opposing first end and second end, wherein an opening is provided at a top end surface of the first end, a first portion and a second portion are provided at an outer side of the implant body, compared with the second portion, the first portion is closer to the first end, a first fixing structure is provided on the first portion, a second fixing structure is provided on the second portion, bionic structures are provided on surfaces of the first portion and the second portion, the bionic structures comprise a plurality of micropores, and diameters of the plurality of micropores are 1 nm to 20 μm.

### TECHNICAL FIELD

The present invention relates to the technical field of dental implantation, and specifically an implant and preparation method thereof.

### BACKGROUND TECHNOLOGY

To implant false teeth is to implant dentures (artificial tooth roots) in an alveolar bone to replace missing teeth in the oral cavity, when the dentures are properly fused, crowns are made thereon to complete repairing of dental implants. In this way, the chewing function of the patient can be significantly improved, the usage of the dentures is comfortable and resembles natural teeth, and there are many clinical cases that have not been addressed by conventional false teeth while have been repaired successfully by implanting dentures.

There are the following defects with the implants currently available which may result in implant failure: natural teeth are connected with bone tissues via tissues to form closed gums, so that bacteria and infections can be prevented from developing into deep regions from the root of the gingival sulcus. However, the dental implants are directly connected with the bone tissue, owing to not sufficiently tight connection between the dental implants and the human body, peri-implantitis is liable to occur for implanted teeth, development of the infection results in absorption of peri-implant bones, and finally implant failure. Therefore, the present invention provides a dental implant and preparation method thereof, to address the problem raised in the background art.

### SUMMARY OF THE INVENTION

The present invention aims to provide an implant and preparation method thereof, wherein, by providing bionic structures, physical signals that stimulate extracellular matrix can be simulated and generated, so as to promote activities such as cell adhesion, proliferation and differentiation, so as to accelerate osseointegration process, promise tight connection between the implants and epithelial cells, reduce the possibility of infection and address the problem raised in the background art.

To realize the foregoing purpose, the present invention provides the following technical solution:

An implant, comprising an implant body, wherein the implant body comprises a first end and a second end, wherein the first end and the second end are opposing, an opening is provided at a top end surface of the first end, a first portion and a second portion are provided at an external surface of the implant, compared with the second portion the first portion is closer to the first end, a first fixing structure is provided on the first portion, a second fixing structure is provided on the second portion, the first fixing structure is different from the second fixing structure, a size of the first portion located along a direction from the first end to the second end is bigger than a size of the second portion located along the direction from the first end and the second end; a bionic structure is provided on a surface of the first portion and/or the second portion, the bionic structure comprises a plurality of micropores, and diameters of the micropores range from 1 nm to 20 nm.

In the present invention, by configuration of the bionic structure, physical signals that stimulate extracellular matrix can be simulated and generated, so as to promote activities such as cell adhesion, proliferation and differentiation, in this way, osseointegration process is accelerated, tight connection between the implant and epithelial cells is promised, and the possibility of infection is reduced. Furthermore, with the surface modification technology, titanium and titanium alloy dental implants with reasonable structures, excellent mechanical performance and surface micron-nanometer topological structures with simulated ossified extracellular matrix skeletons can be constructed.

As a further technical solution of the present invention: the bionic structure comprises a plurality of bionic units, and the plurality of micropores form one of the plurality of bionic units.

As a further technical solution of the present invention: a line linking highest points of the plurality of micropores of one of the plurality of bionic units is a curved line, and a waveform line is formed by connecting the plurality of bionic units.

With this structure configuration, cell multiplication and differentiation can be stimulated to a better extent.

As a further technical solution of the present invention: the plurality of bionic units are configured to be along a direction from the first end to the second end and/or perpendicular to the direction from the first end to the second end.

When some of the plurality of bionic units are oriented along the direction from the first end to the second end and some of the plurality of bionic units are oriented along a direction perpendicular to the direction from the first end to the second end, cells can be stimulated to perform actions such as cell adhesion, multiplication and differentiation along two different directions, the osseointegration process is accelerated and stability after osseointegration is improved.

As a further technical solution of the present invention: the implant further comprises a positioning and sealing assembly, wherein the positioning and sealing assembly specifically comprises: a plurality of vertically aligned upper arc-shaped plates and lower arc-shaped plates, both the plurality of upper arc-shaped plates and the plurality of lower arc-shaped plates are movably connected inside a cavity opened at a top end portion of the first end, and the plurality of upper arc-shaped plates penetrate and extend out of the cavity, arc-shaped push plates are fixed respectively at inner sides of the plurality of lower arc-shaped plates, a sealing ring is connected at sides of the arc-shaped push plates far away from the plurality of lower arc-shaped plates, the sealing ring is inserted in the opening and is movable, first oblique surfaces are provided at bottom end portions of the plurality of upper arc-shaped plates and second oblique surfaces are provided at top end portions of the plurality of lower arc-shaped plates and the second oblique surfaces contact and engage with the first oblique surfaces.

By configuration of the positioning and sealing assembly, proper sealing can be done in between the abutment and the opening, further, the position of the abutment can be limited, and influence on subsequent screw fixing due to displacement of the abutment can be avoided.

As a further technical solution of the present invention: the implant further comprises an abutment, the abutment comprises an intermediate abutment, an upper abutment is fixed on a top portion of the intermediate abutment, a lower abutment is connected at a center of a bottom end surface of the intermediate abutment, the lower abutment can be inserted into the opening and fixed with the implant body, and a plurality of slots aligned with the plurality of upper arc-shaped plates are provided along the bottom end surface of the intermediate abutment.

When connecting the abutment with the implant body, first of all, inserting the lower abutment of the abutment into the opening, during inserting, aligning the plurality of slots with the plurality of upper arc-shaped plates, so as to promise that during inserting the plurality of upper arc-shaped plates can be inserted into the plurality of slots, and limit the position of the abutment, subsequently the screw can be implanted to fix the abutment, and a depth of the plurality of slots is small, by screwing the screw gradually in, the bottom end surface of the intermediate abutment is more and more close to a top end surface of the first end, so as to press the plurality of upper arc-shaped plates downwards, and under action of both the first inclining plate and the second inclining plate, the plurality of lower arc-shaped plates are extruded to move towards the opening by the plurality of upper arc-shaped plates so as to push the arc-shaped push plates, extrude the sealing ring inwards, and in conjunction with gradual penetration of the lower abutment in the opening, the sealing ring is abutted snugly on an outer surface of the lower abutment, so as to improve sealing effects between the abutment and the opening. As a further technical solution of the present invention: the implant further comprises a first fixing assembly, wherein the first fixing assembly comprises a first male thread structure, a cross section of a tooth of the first male thread structure is a triangle or trapezoid, the implant further comprises a second fixing assembly, wherein the second fixing assembly comprises a second male thread structure, and a cross section of a tooth of the second male thread structure comprises a trapezoidal upper surface and a concave lower surface.

By providing the two male threads, and configuring the cross section of the tooth of the first male thread structure to be trapezoid or triangle, and the cross section of the tooth of the second male thread structure to be trapezoid upper surface, by mutual collaboration of the two male threads, the purpose of enhancing stability of the implant can be reached, so it is convenient for the dentist to install the crown on the abutment on the implant after recovery, firmness of the tooth is improved, connection is tighter, stability of the tooth is enhanced, installation difficulty is reduced and tooth installation is more convenient.

A preparation method of the implant, comprising the following steps:
Step 1: preparing a first mold corresponding to a shape of the implant;
Step 2: forming a shaping substance of the bionic structure at an inner surface of the first mold;
Step 3: preparing a blank of the implant in the first mold, and a surface of the blank comprises the shaping substance; and
Step 4: removing the shaping substance on the blank of the implant and obtaining the implant.

In the present invention, the preparation method of the dental implant is easy and convenient, the bionic structure on the surface is stable, and exhibits good effects, and no hazardous solvent residue is observed, which is safe and environment friendly.

A preparation method of the implant, comprising the following steps:
Advance step: putting into a second mold a first raw material of the implant, and obtaining a matrix;
Step 1: preparing a first mold corresponding to a shape of the implant;
Step 2: forming a shaping substance of the bionic structure at an inner surface of the first mold;
Step 3: depositing a second raw material uniformly on the inner surface of the first mold, placing the matrix on the second raw material, preparing and forming a blank of the implant, wherein a surface of the blank comprises the shaping substance;
Step 4: removing the shaping substance of the blank of the implant and obtaining the implant.

As a further technical solution of the present invention: in step 4, the shaping substance is dissolved and then removed.

Compared with the prior art, the beneficial effects of the present invention are:
1. In the present invention, a bionic structure is built, physical signals can be simulated and generated to stimulate extracellular matrix, so as to promote cell adhesion, multiplication and differentiation etc., and the osseointegration process can be accelerated. And with the surface modification technology, titanium and titanium alloy implants with reasonable structures, excellent mechanical performance and surface micron-nanometer topological structure with simulated ossified extracellular matrix skeleton can be constructed.
2. In the present invention, by providing some of the plurality of bionic units along the direction from the first end to the second end and the other of the plurality of bionic units to orient perpendicular to the direction from the first end to the second end, cell activities such as cell adhesion, multiplication and differentiation along the two different directions can be stimulated to accelerate osseointegration and in the meanwhile, increase the osseointegration stability.
3. In the present invention, by providing the two kinds of male threads on the implant, and configuration of the cross section of the tooth of the first male thread structure to be trapezoid or triangle, and the cross section of the tooth of the second male thread structure to be trapezoidal upper surface, and by engagement of the male threads, stability of the implant can be improved, it is convenient for the dentist to install the crown on the abutment on the implant, in the meanwhile, the firmness of the tooth is enhanced, connection becomes tighter, stability of the tooth is improved, installation difficulty is reduced and tooth installation work is more convenient.
4. The preparation method of the implant according to the present invention is simple and fast, the bionic structure on the surface is stable and of good effects, and no hazardous solvent residue is observed, which is safe and environment friendly.
5. In the present invention, by configuration of the positioning and limiting assembly, when connecting the abutment with the implant, first of all, inserting the lower abutment into the opening, during insertion, aligning the slots and the upper arc-shaped plates, to promise during insertion the upper arc-shaped plates can be inserted into the slots, and to limit the position of the abutment, and make it convenient to implant the screw for fixture, the depth of the slots is small, with gradual deepening of the screw, the bottom end surface of the intermediate abutment is closer and closer to the top end surface of the first end, pressing the upper arc-shaped plates downwards, under actions of the first oblique surfaces and the second oblique surfaces, the lower arc-shaped plates are extruded to move towards the direction of the opening by the upper arc-shaped plates, the arc-shaped push plates are pushed to extrude the sealing ring, with the gradual deepening of the lower abutment in the opening, the sealing ring is abutted firmly at the outside of the lower abutment and sealing tightness between the abutment and the opening is improved.

### BRIEF DESCRIPTION OF DRAWINGS

FIG. 1 is a structural diagram showing an implant according to the present invention;

FIG. 2 is a cross-section diagram of the implant cutting along A-A as marked in FIG. 1 according to the present invention;

FIG. 3 is an enlarged diagram showing a part B as marked in FIG. 2 of the present invention;

FIG. 4 is an enlarged partial diagram of a surface of the implant according to the present invention;

FIG. 5 is an enlarged diagram of a part C as marked in FIG. 2 of the present invention;

FIG. 6 is a structural diagram showing a positioning and sealing assembly according to the present invention;

FIG. 7 is a structural diagram showing an abutment according to the present invention; and

FIG. 8 is a side view of the abutment according to the present invention.

In the drawings: 100 implant; 110 implant body; 111 first end; 112 second end; 1110 opening; 113 first portion; 114 second portion; 1130 first fixing structure; 1140 second fixing structure; 120 bionic unit; 1201 micropore; 130 positioning and sealing assembly; 131 upper arc-shaped plate; 132 lower arc-shaped plate; 133 arc-shaped push plate; 134 sealing ring; 135 first oblique surface; 136 second oblique surface; 140 abutment; 141 intermediate abutment; 142 upper abutment; 143 lower abutment; and 144 slot.

### EMBODIMENTS

Hereinafter a clear and complete description will be given to the technical solutions in the embodiments of the present invention in conjunction with the drawings to be used in description of the embodiments, apparently, the embodiments given here are only some of the embodiments of the present invention rather than all. Based on the embodiments provided in the present invention, all other embodiments obtained by those of ordinary skill in the art without paying creative effort shall fall into the protection scope of the present invention.

### Embodiment 1

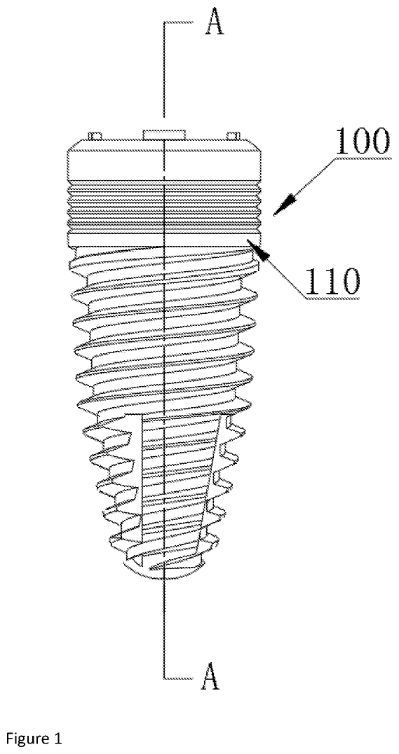

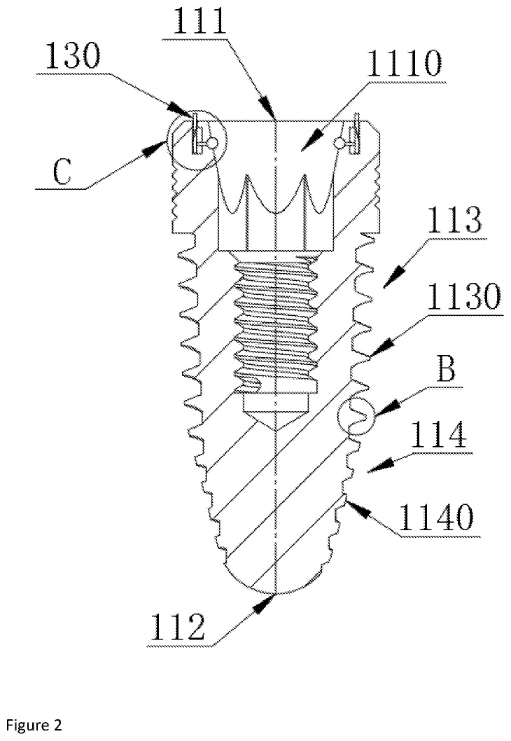

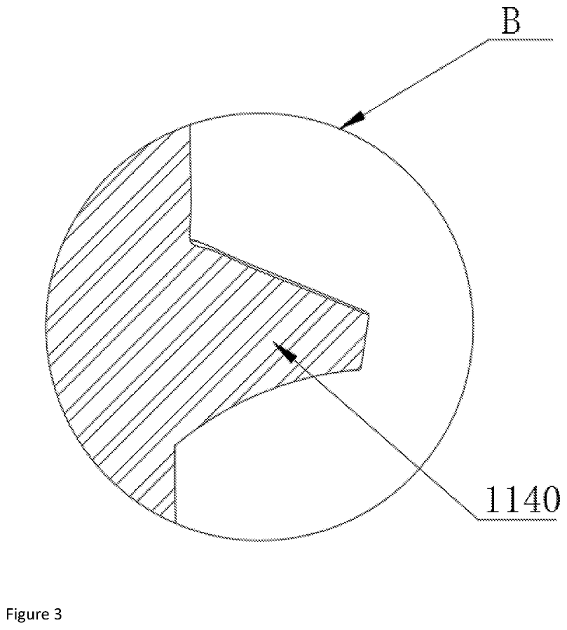

As shown in FIGS. 1-3, the present invention provides the following technical solution: an implant 100, comprising an implant body 110, wherein the implant body 110 comprises a first end 111 and a second end 112 that are opposing; an opening 1110 is provided at a top end surface of the first end 111, a diameter of the opening 1110 is 1.5 mm, so to house at least partially an abutment and be combined with the abutment.

A first portion 113 and a second portion 114 are provided at an outer surface of the implant body 110, the first portion 113 is closer to the first end 110 compared with the second portion 114, a first fixing structure 1130 is provided at the first portion 113, a second fixing structure 1140 is provided at the second portion 114, and the first fixing structure 1130 is different from the second fixing structure 1140. The first fixing structure 1130 comprises a first male thread structure, and a cross section of a tooth of the first male thread structure is a triangle, the second fixing structure 1140 comprises a second male thread structure, a cross section of a tooth of the second male thread structure is divided into a trapezoidal upper portion and an inwardly curved lower surface. Further, a thread pitch of the first male thread structure is 0.3 mm. Along a direction linking the first portion 113 and the second portion 114, the thread of the second male thread structure on the second portion is reduced in size gradually.

A dimension of the first portion 113 on the direction linking the first portion 113 and the second portion 114 is bigger than a dimension of the second portion 114 on the direction linking the first portion 113 and the second portion 114.

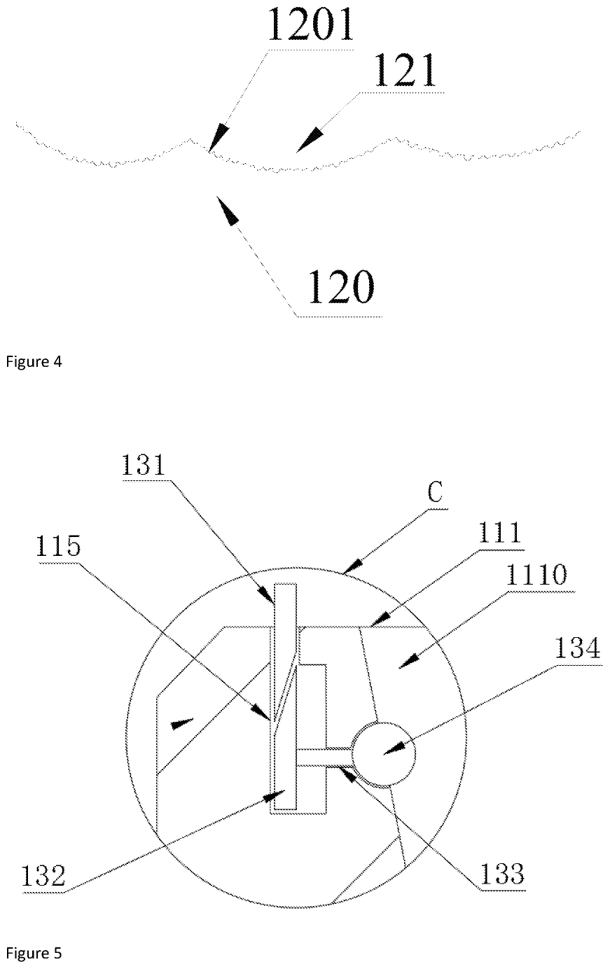

Furthermore, a bionic structure 120 is provided at a surface of the first portion 113 and the second portion 114, the bionic structure 120 comprises a plurality of micropores 1201, wherein diameters of the plurality of micropores 1201 ranges from 1-15 nm. The bionic structure 120 comprises a plurality of bionic units 121, and several micropores 1201 form a bionic unit 121. As shown in FIG. 4, a line linking highest points of the plurality of micropores 1201 of one of the plurality of bionic units 121 is a curved line, and a line linking the plurality of bionic units 121 forms a wave form line. Some of the plurality of bionic units 121 are provided in the direction from the first end 111 to the second end 112; some of the plurality of bionic units 121 are provided in a direction perpendicular to the direction from the first end 111 to the second end 112. Further, a dimension of the plurality of bionic units 121 at the said direction is 20 μm.

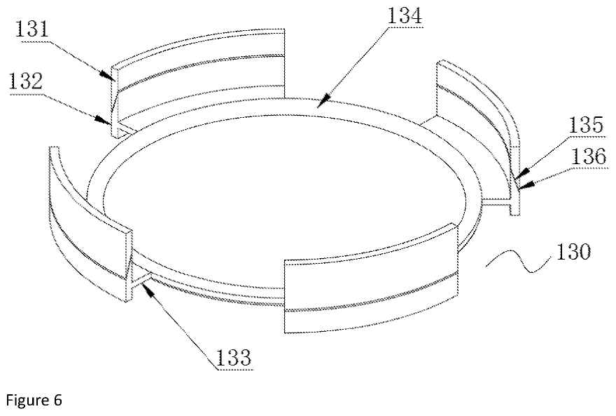

In the present embodiment: as shown in FIGS. 5 and 6, the implant further comprises a positioning and sealing assembly 130, wherein the positioning and sealing assembly 130 specifically comprises: a plurality of aligned upper arc-shaped plates 131 and lower arc-shaped plates 132, both the plurality of upper arc-shaped plates 131 and the plurality of lower arc-shaped plates 132 are movably connected in a cavity 115 opened at a top portion of the first end 111, top portions of the plurality of upper arc-shaped plates 131 penetrate the cavity 115 and extend out of the cavity 115, inner surfaces of the plurality of lower arc-shaped plates 132 are connected with arc-shaped push plates 133, sides of the arc-shaped push plates 133 far away from the plurality of lower arc-shaped plates 132 are connected with a sealing ring 134, the sealing ring 134 is inserted in the opening 1110 and is movable, first oblique surfaces 135 are provided at bottom ends of the plurality of upper arc-shaped plates 131, second oblique surfaces 136 are provided at upper ends of the plurality of lower arc-shaped plates 132 and the second oblique surfaces 136 are aligned with the first oblique surfaces 135. By configuration of the positioning and sealing assembly 130, sealing between the abutment 140 and the opening 1110 can be improved, the position of the abutment can be limited and influence of displacement of the abutment on subsequent screw fitting can be avoided.

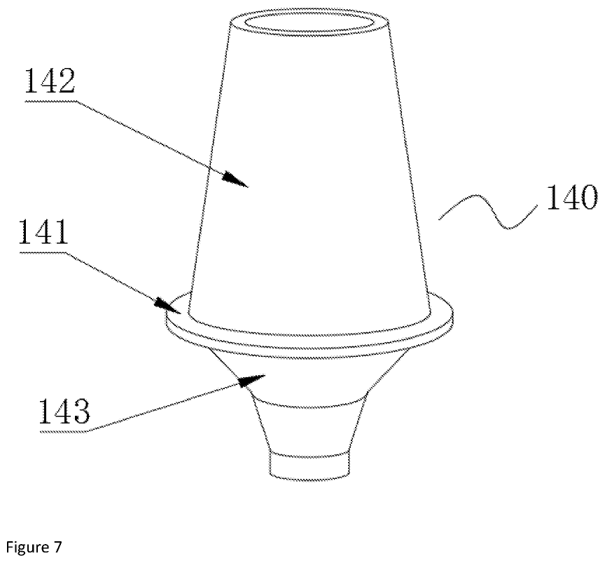

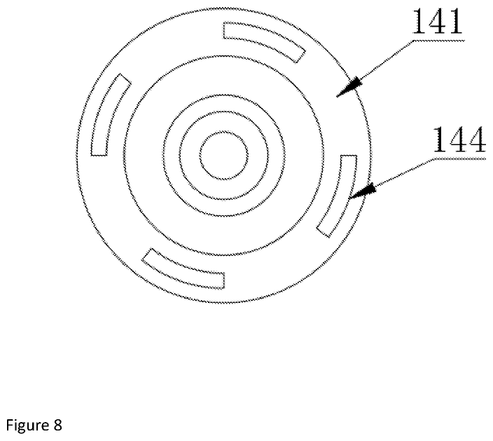

In the present embodiment: as shown in FIGS. 7 and 8, the implant further comprises the abutment 140, the abutment 140 comprises an intermediate abutment 141, an upper abutment 142 is connected at a top end surface of the intermediate abutment 141, a lower abutment 143 is connected at a center of a bottom end surface of the intermediate abutment 141, the lower abutment 143 can be inserted into the opening 1110 and fixed on the implant body 110 via the screw, and a plurality of slots 144 aligned with the plurality of upper arc-shaped plates are provided circumferentially along a bottom end surface of the intermediate abutment 141. When connecting the abutment 140 with the implant body 110, first of all, inserting the lower abutment 143 of the abutment 140 into the opening 1110, during insertion, aligning the plurality of slots 144 with the plurality of upper arc-shaped plates 131 to promise during insertion the plurality of upper arc-shaped plates 131 can be inserted into the plurality of slots 144, and limit the position of the abutment 140 and facilitate fixing of the screw, furthermore, a depth of the plurality of slots 144 is low, therefore, with the gradual deepening of the screw, the bottom end surface of the intermediate abutment 141 is closer and closer to the top end surface of the first end 111, so as to press the plurality of upper arc-shaped plates 131 downwards, under action of both the first oblique surfaces 135 and the second oblique surfaces 136, the plurality of upper arc-shaped plates 132 are pressed to move towards the opening 1110 by the plurality of upper arc-shaped plates 131, so as to push the arc-shaped push plates 133 and squeeze the sealing ring 134 inwards, in conjunction with the gradual deepening of the lower abutment 143 into the opening 1110, the sealing ring 134 is abutted firmly on an outer surface of the lower abutment 143 to improve sealing between the abutment 140 and the opening 1110, and after fixing the abutment 140, wear the crown on the upper abutment 142.

After culturing epithelial cells on a surface of the implant 100, upon SEM observation, it is observed that: connection between the implant 100 and the epithelial cells is tight, no dental plaque is observed and no infection occurs too.

### Embodiment 2

As shown in FIGS. 1-3, the present invention provides the following technical solution: an implant 100, comprising an implant body 110, the implant body 110 comprises a first end 111 and a second end 112 and the first end 111 and the second end 112 are opposing, an opening 1110 is provided at a top end surface of the first end 111, a diameter of the opening 1110 is 2.3 mm, so as to at least partially house the abutment and be combined with the abutment.

A first portion 113 and a second portion 114 are provided at an outer surface of the implant body 110, the first portion 113 is closer to the first end 111 compared with the second portion 114, a first fixing structure 1130 is provided on the first portion 113, and the first fixing structure 1130 is different from the second fixing structure 1140. The first fixing structure 1130 comprises a first male thread structure, a cross section of the first male thread structure is a trapezoid, the second fixing structure 1140 comprises a second male thread structure, and a cross section of a thread of the second male thread structure comprises an upper trapezoidal surface and a lower inwardly curved surface. Further, a thread pitch of the first male thread structure is 0.5 mm. Along a direction connecting the first portion 113 and the second portion 114, the thread of the second male thread structure is gradually reduced in dimension.

A dimension of the first portion at the direction from the first end 111 to the second end 112 is bigger than a dimension of the second portion 114 at the direction of the first end 111 to the second end 112.

Furthermore, a bionic structure 120 is provided at a surface of the first portion 113, the bionic structure 120 comprises a plurality of micropores 1201, and diameters of some of the plurality of micropores 1201 range from 30-50 nm and diameters of the other of the plurality of micropores 1201 range from 1-10 μm. preferably, the bionic structure 120 comprises a plurality of bionic units 121, a plurality of micropores 1201 form one of the plurality of bionic units 121, specifically, some of the plurality of bionic units 121 comprise the plurality of micropores with diameters 30-50 nm and the other of the plurality of bionic units 121 comprise the plurality of micropores with diameters 1-10 μm. As shown in FIG. 4, a line connecting highest points of the plurality of micropores 1201 of one of the plurality of bionic units 121 is a curved line, and a line linking the plurality of bionic units 121 is a wave form line. The plurality of bionic units 121 are provided along a direction oriented from the first end 111 to the second end 112 and/or perpendicular to a direction linking the first end 111 and the second end 112, however, the present invention is not limited to this configuration, and the direction of the plurality of bionic units 121 can be different. Further, dimensions of the plurality of bionic units 121 along the said direction fall into a range of 20-100 μm.

In the present embodiment: as shown in FIGS. 5 and 6, the implant 100 further comprises a positioning and sealing assembly 130, specifically the positioning and sealing assembly 130 comprises a plurality of aligned upper arc-shaped plates 131 and lower arc-shaped plates 132, both the plurality of upper arc-shaped plates 131 and the plurality of lower arc-shaped plates 132 are movably connected inside a cavity 115 opened at a top end of the first end 111, the top end of the plurality of upper arc-shaped plates 131 penetrate and extend out of the cavity 115, arc-shaped push plates 133 are provided at inner surfaces of the plurality of arc-shaped plates 132, and a sealing ring 134 is connected at a side of the arc-shaped push plates 133 away from the plurality of lower arc-shaped plates 132, the sealing ring 134 is inserted into the opening 1110 and is movable, first oblique surfaces 135 are provided at bottom end portions of the plurality of upper arc-shaped plates 131, second oblique surfaces 136 are provided at top end portions of the plurality of lower arc-shaped plates 132 and the first oblique surfaces 135 and the second oblique surfaces 136 are mutually aligned. By configuration of the positioning and sealing assembly 130, not only the sealing between the abutment 140 and the opening 1110 can be improved, the abutment 140 can be limited and influence of displacement of the abutment 140 on subsequent screw fitting can be avoided.

In the present embodiment: as shown in FIGS. 7 and 8, the implant 100 further comprises the abutment 140, the abutment 140 comprises an intermediate abutment 141, an upper abutment 142 is provided at a top end surface of the intermediate abutment 141, a lower abutment 143 is fixed at a center of a bottom end surface of the intermediate abutment 141, the lower abutment 143 can be inserted into the opening 1110 and connected with the implant body 110 via the screw, and a plurality of slots 144 aligned with the plurality of upper arc-shaped plates 131 are opened circumferentially along a bottom end surface of the intermediate abutment 141. When to connect the abutment 140 with the implant body 110, first of all, inserting the lower abutment 143 of the abutment 140 into the opening 1110, during inserting, aligning the plurality of slots 144 with the plurality of upper arc-shaped plates 131 to promise that during insertion, the plurality of upper arc-shaped plates 131 can be inserted into the plurality of slots 144, the position of the abutment 140 can be limited, and subsequent screw fitting work can be facilitated, in the meanwhile, as a depth of the plurality of slots 144 is low, with the gradual deepening of the screw, a bottom end surface of the intermediate abutment 141 is closer and closer to a top end surface of the first end 111 so as to press the plurality of upper arc-shaped plates 131 downwards, under action of the oblique surface of both the first oblique surfaces 135 and the second oblique surfaces 136, the plurality of lower arc-shaped plates 132 are pressed by the plurality of upper arc-shaped plates 131 to move towards the opening 1110, thereafter, the arc-shaped push plates 133 are pushed to squeeze the sealing ring 134 inwards, in conjunction with gradual penetration of the lower abutment 143 in the opening 1110, the sealing ring 134 is abutted firmly on an outer surface of the lower abutment 143, the sealing between the abutment 140 and the opening 1110 is improved, and after fixing the abutment 140, wear the crown on the upper abutment 142.

After culturing epilithal cells on a surface of the implant 100, SEM observation is conducted and it is observed that: connection between the implant 100 and the epithelial cells is tight, no dental plaque is formed and no infection occurs.

### Embodiment 3

As shown in FIGS. 1-3, the present invention provides the following technical solution: an implant 100, comprising an implant body 110, wherein the implant body 110 comprises a first end 111 and a second end 112, the first end 111 and the second end 112 are opposing, an opening 1110 is provided at a top end surface of the first end 111, a diameter of the opening 1110 is 6 mm so that the opening 1110 can at least partially house and be combined with the abutment.

A first portion 113 and a second portion 114 are provided at an outer surface of the implant body 110, compared with the second end 114, the first end 113 is closer to the first end 111, a first fixing structure 1130 is provided on the first portion 113, a second fixing structure 1140 is provided on the second portion 114, and the first fixing structure 1130 is different from the second fixing structure 1140. The first fixing structure 1130 comprises a first male thread structure, a cross section of a thread of the first male thread structure is a triangle, the second fixing structure 1140 comprises a second male thread structure, a cross section of a thread of the second male thread structure comprises an trapezoidal upper surface and a concave lower surface, and the configuration of the threads of the first male thread structure and the second male thread structure is not limited to this. Further, a thread pitch of the first male thread structure is 0.3-0.6 mm. At a direction from the first portion 113 to the second portion 114, the thread of the second male thread structure of the second portion 114 is gradually reduced.

A dimension of the first portion 113 at the direction from the first portion 113 to the second portion 114 is bigger than a dimension of the second portion 114 at the direction from the first portion 113 to the second portion 114.

Furthermore, a bionic structure 120 is provided at a surface of the first portion 113 and/or the second portion 114, the bionic structure 120 comprises a plurality of micropores 1201, and diameters of the plurality of micropores 1201 range from 1-10 μm. Preferably, the bionic structure 120 comprises a plurality of bionic units 121, and one of the plurality of bionic units 121 is formed by the plurality of micropores 1201. As shown in FIG. 4, a line connecting highest points of the plurality of micropores 1201 of one of the plurality of bionic units 121 resembles an arc, and a line connecting the plurality of bionic units 121 resembles a waveform line. The plurality of bionic units 121 are configured along a direction oriented from the first end 111 to the second end 112 and/or along a direction perpendicular to the direction from the first end 111 to the second end 112, and the configuration of the plurality of bionic units 121 is not limited to this, the direction of the plurality of bionic units 121 can be different. Further, a dimension of the plurality of bionic units 12 along the said direction is 50 μm.

In the present embodiment: as shown in FIGS. 5-6, the implant 100 further comprises a positioning and sealing assembly 130, wherein the positioning and sealing assembly 130 specifically comprises: a plurality of aligned upper arc-shaped plates 131 and lower arc-shaped plates 132, both the plurality of upper arc-shaped plates 131 and the plurality of lower arc-shaped plates 132 are movably provided in a cavity 115 opened at a top end of the first end 111, and top end portions of the plurality of upper arc-shaped plates 131 penetrate and extend out of the cavity 115, arc-shaped push plates 133 are fixed at inner sides of the plurality of lower arc-shaped plates 132, a sealing ring 134 is connected at sides of the arc-shaped push plates 133 away from the plurality of lower arc-shaped plates 132, the sealing ring 134 is inserted in the opening 1110 and is movable, first oblique surfaces 135 are provided at bottom end portions of the plurality of upper arc-shaped plates 131, second oblique surfaces 136 are provided at top end portions of the plurality of lower arc-shaped plates 132, and the second oblique surfaces 136 contact and are aligned with the first oblique surfaces 135. By configuration of the positioning and sealing assembly 130, not only sealing between the abutment 140 and the opening 1110 can be improved, the abutment 140 can be limited, and influence of displacement of the abutment 140 on subsequent screw fixing can be avoided.

In the present embodiment: as shown in FIGS. 7 and 8, the implant 100 further comprises an abutment 140, wherein the abutment 140 comprises an intermediate abutment 141, an upper abutment 142 is connected at a top end surface of the intermediate abutment 141, a lower abutment 143 is fixed at a center of a bottom end surface of the intermediate abutment 141, and a plurality of slots 144 aligned with the plurality of upper arc-shaped plates 131 are provided circumferentially along a bottom end portion of the intermediate abutment 141. When to connect the abutment 140 with the implant body 110, first of all, insert the lower abutment 143 of the abutment 140 into the opening 1110, during insertion, align the plurality of slots 144 with the plurality of upper arc-shaped plates 131, ensure that during insertion the plurality of upper arc-shaped plates 131 can be inserted in the plurality of slots 144, so that the position of the abutment 140 can be limited, subsequent screw fitting can be facilitated, furthermore, the depth of the plurality of slots 144 is low, with the gradual penetration of the screw, the bottom end surface of the intermediate abutment 141 is closer and closer to the top end surface of the first end 111, the plurality of upper arc-shaped 131 is pressed downwards, under action of oblique surfaces of the first oblique surfaces 135 and the second oblique surfaces 136, the arc-shaped push plates 133 are pushed to squeeze the sealing ring 134 inwards, also with the gradual penetration of the lower abutment 143 in the opening 1110, the sealing 134 is firmly abutted against an outer surface of the lower abutment 143, in this way, sealing between the abutment 140 and the opening 1110 is improved, and installation is done after fixing the abutment 140 and wearing the crown on the upper abutment 142.

After culturing epithelial cells at a surface of the implant 100, upon SEM observation, it is found that: connection between the implant 100 and the epithelial cells is tight, no dental plaque is observed and no infection occurs.

### Embodiment 4

As shown in FIGS. 1-3, the present invention provides the following technical solution: an implant 100, comprising an implant body 110, wherein the implant body 110 comprises a first end 111 and a second end 112, and the first end and the second end 112 are opposing, an opening 1110 is provided at a top end surface of the first end 111, a diameter of the opening 1110 is 6 mm, so that the opening 1110 can at least partially house and be combined with the abutment.

The implant body 110 comprises a first portion 113 and a second portion 114, compared with the second portion 114 the first portion 113 is closer to the first end 111, the first portion 113 is provided with a first fixing structure 1130, the second portion 114 is provided with a second fixing structure 1140, and the first fixing structure 1130 is different from the second fixing structure 1140. The first fixing structure 1130 comprises a first male thread structure, a cross section of a thread of the first male thread structure is a triangle, the second fixing structure 1140 is a second male thread structure, and a cross section of a thread of the second male thread structure comprises an trapezoidal upper surface and an inwardly curved lower surface, and the configuration of the first male thread structure and the second male thread structure is not limited thereto. Further, a thread pitch of the first male thread structure is 0.6 mm. Along a direction from the first portion 113 to the second portion 114, the thread of the second male thread structure of the second portion 114 is gradually reduced in dimension.

A dimension of the first portion 11 at the direction from the first end 111 to the second end 112 is bigger than a dimension of the second portion at the direction from the first end 111 to the second end 112.

Furthermore, a bionic structure 120 is provided at a surface of the first portion 113 and/or a surface of the second portion 114, the bionic structure 120 comprises a plurality of micropores 1201, and diameters of the plurality of micropores 1201 fall in a range of 10-20 μm. Preferably, the bionic structure 120 comprises a plurality of bionic units 121, and one of the plurality of bionic units 121 comprises the plurality of micropores 1201. As shown in FIG. 4, a line linking highest points of the plurality of micropores 1201 of the plurality of bionic units 121 resembles an arc, and a line linking the plurality of bionic units 121 resembles a waveform line. The plurality of bionic units 121 are provided along a direction perpendicular to a direction oriented from the first end 111 to the second end 112. Further, dimensions of the plurality of bionic units 121 along the said direction are 40-60 μm.

In the present embodiment: as shown in FIGS. 5-6, the implant 100 further comprises a positioning and sealing assembly 130, wherein the positioning and sealing assembly 130 specifically comprises: a plurality of aligned upper arc-shaped plates 131 and lower arc-shaped plates 132, both the plurality of upper arc-shaped plates 131 and the plurality of lower arc-shaped plates 132 are movably connected inside a cavity opened at a top end of the first end 111, top ends of the plurality of upper arc-shaped plates 131 penetrate and extend out of the cavity 115, arc-shaped push plates 133 are connected at inner sides of the plurality of lower arc-shaped plates 132, and a sealing ring 134 is provided at sides of the arc-shaped push plates 133 away from the plurality of lower arc-shaped plates 132, the sealing ring 134 is inserted in the opening 1110 and is movable, first oblique surfaces 135 are provided at bottom ends of the plurality of upper arc-shaped plates 131, and second oblique surfaces 135 are provided at top ends of the lower arc-shaped plates 132 and the second oblique surfaces 136 contact and are aligned with the first oblique surfaces 135. By configuration of the positioning and sealing assembly 130, not only sealing between the abutment 140 and the opening 1110 can be improved, the position of the abutment 140 can be limited and influence by displacement of the abutment 140 on subsequent screw fixing can be avoided.

In the present embodiment: as shown in FIGS. 7 and 8, the implant 100 further comprises an abutment 140, the abutment 140 comprises an intermediate abutment 141, an upper abutment 142 is fixed at a top end surface of the intermediate abutment 141, a lower abutment 143 is connected at a center of a bottom end surface of the intermediate abutment 141, the lower abutment 143 can be inserted into the opening 1110 and connected with the implant body 110, and a plurality of slots 144 aligned with the plurality of upper arc-shaped plates 131 are opened circumferentially along a bottom end surface of the intermediate abutment 141. When to connect the abutment 140 and the implant body 110, first of all, insert the lower abutment 143 of the abutment 140 into the opening 1110, during insertion, align the plurality of slots 144 and the plurality of upper arc-shaped plates 131, ensure that during insertion the plurality of upper arc-shaped plates 131 can be inserted into the plurality of slots 144 so as to limit the position of the abutment 140, and subsequent fixing of the screw can be facilitated, furthermore, a depth of the plurality of slots 144 is low, with the gradual penetration of the screw, the bottom end surface of the intermediate abutment 141 is closer and closer to a top end surface of the first end 111, the plurality of upper arc-shaped plates 131 are pressed downwards, under joint action of the first oblique surfaces 135 and the second oblique surfaces 136, the plurality of lower arc-shaped plates 132 are forced to move towards the opening 1110 by the plurality of upper arc-shaped plates 131, the arc-shaped push plates 133 are thus pushed to squeeze the sealing ring 134 inwards, in conjunction with the gradual penetration of the lower abutment 143 in the opening 1110, the sealing ring 134 is firmly abutted to an outer surface of the lower abutment 143, therefore, sealing between the abutment 140 and the opening 1110 is improved, thereafter, fix the abutment 140 and wear the crown on the upper abutment 142.

Culturing epithelial cells on a surface of the implant 100, upon SEM observation, it is found that: connection between the implant 100 and the epithelial cells is tight, no dental plaque is observed and no infection occurs.

### Embodiment 5

A preparation method of the implant 100 as shown in embodiment 1, wherein the preparation method comprises the following steps:
Step 1: preparing a first mold corresponding to a shape of the implant 100;
Step 2: forming a shaping substance of the bionic structure 120 at an inner surface of the first mold, wherein the shaping substance comprises crystal particles with diameters of 1-15 nm soluble in water, such as salt crystals and naphthalene crystals;
Step 3: preparing and forming a blank of the implant 100 in the first mold, wherein a surface of the blank comprises the shaping substance; and
Step 4: removing the shaping substance from the blank of the implant 100, immersing the blank in water of 50° C. for one hour, introducing the positioning and sealing assembly 130 and obtaining the implant 100.

### Embodiment 6

A preparation method of the implant 100 as shown in embodiment 2, wherein the preparation method comprises the following steps:

Advance step: placing a first raw material of the implant 100 in a second mold, and obtaining a basal body;
Step 1: preparing a first mold corresponding to a shape of the implant 100;
Step 2: forming a shaping substance of the bionic structure 120 at a surface of the first mold, wherein the shaping substance comprises crystals with diameters 30-50 nm and soluble in water and crystals with diameters 1-10 μm and soluble in water;
Step 3: laying a second raw material evenly on an inner surface of the first mold, placing the basal body on the second raw material, preparing and forming a blank of the implant 100, wherein a surface of the blank comprises the shaping substance; and
Step 4: removing the shaping substance on the blank of the implant 100, immersing the blank in water 50-100° C. for 0.5-1 hour and introducing the positioning and sealing assembly 130, and obtaining the implant 100.

### Embodiment 7

A preparation method of the implant 100 as shown in embodiment 3, wherein the preparation method comprises the following steps:
Step 1: preparing a first mold corresponding to a shape of the implant 100;
Step 2: forming a shaping substance of the bionic structure 120 at an inner surface of the first mold, wherein the shaping substance comprises crystal particles with diameters 1-10 μm and soluble in water, for example, salt crystals and naphthalene crystals;
Step 3: preparing a blank of the implant 100 in the first mold, wherein a surface of the blank comprises the shaping substance; and
Step 4: removing the shaping substance on the blank of the implant 100, immersing the blank in water 60° C. for 0.8 hour, introducing the positioning and sealing assembly 130 and obtaining the implant 100.

### Embodiment 8

A preparation method of the implant 100 as shown in embodiment 4, wherein the preparation method comprises the following steps:

Advance step: placing a first raw material for preparing the implant 100 in a second mold and obtaining a basal body;
Step 1: preparing a first mold corresponding to a shape of the implant 100;
Step 2: forming a shaping substance of the bionic structure 120 at an inner surface of the first mold, wherein the shaping substance comprises crystals soluble in water and with diameters 10-20 μm, for example salt crystals and naphthalene crystals; Step 3: depositing a second raw material at the inner surface of the first mold, placing the basal body on the first raw material, preparing and forming a blank of the implant 100, wherein a surface of the blank comprises the shaping substance;
Step 4: removing the shaping substance of the blank of the implant 100, immersing the blank in water 100° C. for 0.5 hour, introducing the positioning and sealing assembly 130 and obtaining the implant 100.

Apparently, those skilled in the art can make various modifications and alterations to the present invention without departing from the spirit and scope of the present invention. In case that such modifications and alterations fall into the scope of the claims and equivalent technical solutions of the present invention, the present invention is intended to cover these modifications and alterations.

The foregoing are merely some preferred embodiments of the present invention, however, the protection scope of the present invention is not limited to the embodiment disclosed herein, any modification or equivalent replacement made by those skilled in the art within the technical scope disclosed in the present invention and made based on the technical solutions and ideas of the present invention shall be covered in the protection scope of the present invention.

1. An implant, comprising an implant body, wherein the implant body comprises a first end and a second end, wherein the first end and the second end are opposing, an opening is provided at a top end surface of the first end, a first portion and a second portion are provided at an external surface of the implant, compared with the second portion the first portion is closer to the first end, a first fixing structure is provided on the first portion, a second fixing structure is provided on the second portion, the first fixing structure is different from the second fixing structure, a size of the first portion located along a direction from the first end to the second end is bigger than a size of the second portion located along the direction from the first end and the second end; a bionic structure is provided on a surface of the first portion and/or the second portion, the bionic structure comprises a plurality of micropores, and diameters of the micropores range from 1 nm to 20 nm.

2. The implant according to claim 1, wherein the bionic structure comprises a plurality of bionic units, and the plurality of micropores form one of the plurality of bionic units.

3. The implant according to claim 2, wherein a line linking highest points of the plurality of micropores of one of the plurality of bionic units is a curved line, and a waveform line is formed by connecting the plurality of bionic units.

4. The implant according to claim 2, wherein the plurality of bionic units are configured to be along a direction from the first end to the second end and/or perpendicular to the direction from the first end to the second end.

5. The implant according to claim 1, wherein the implant further comprises a positioning and sealing assembly, wherein the positioning and sealing assembly specifically comprises: a plurality of vertically aligned upper arc-shaped plates and lower arc-shaped plates, both the plurality of upper arc-shaped plates and the plurality of lower arc-shaped plates are movably connected inside a cavity opened at a top end portion of the first end, and the plurality of upper arc-shaped plates penetrate and extend out of the cavity, arc-shaped push plates are fixed respectively at inner sides of the plurality of lower arc-shaped plates, a sealing ring is connected at sides of the arc-shaped push plates far away from the plurality of lower arc-shaped plates, the sealing ring is inserted in the opening and is movable, first oblique surfaces are provided at bottom end portions of the plurality of upper arc-shaped plates and second oblique surfaces are provided at top end portions of the plurality of lower arc-shaped plates and the second oblique surfaces contact and engage with the first oblique surfaces.

6. The implant according to claim 5, wherein the implant further comprises an abutment, the abutment comprises an intermediate abutment, an upper abutment is fixed on a top portion of the intermediate abutment, a lower abutment is connected at a center of a bottom end surface of the intermediate abutment, the lower abutment can be inserted into the opening and fixed with the implant body, and a plurality of slots aligned with the plurality of upper arc-shaped plates are provided along the bottom end surface of the intermediate abutment.

7. The implant according to claim 1, wherein the implant further comprises a first fixing assembly, wherein the first fixing assembly comprises a first male thread structure, a cross section of a tooth of the first male thread structure is a triangle or trapezoid, the implant further comprises a second fixing assembly, wherein the second fixing assembly comprises a second male thread structure, and a cross section of a tooth of the second male thread structure comprises a trapezoidal upper surface and a concave lower surface.

8. A preparation method of the implant according to claim 1, comprising the following steps:
(step 1): preparing a first mold corresponding to a shape of the implant;
(step 2): forming a shaping substance of the bionic structure at an inner surface of the first mold;
(step 3): preparing a blank of the implant in the first mold, and a surface of the blank comprises the shaping substance; and
(step 4): removing the shaping substance on the blank of the implant and obtaining the implant.

9. A preparation method of the implant according to claim 1, comprising the following steps:
(advance step): putting into a second mold a first raw material of the implant, and obtaining a matrix;
(step 1): preparing a first mold corresponding to a shape of the implant;
(step 2): forming a shaping substance of the bionic structure at an inner surface of the first mold;
(step 3): depositing a second raw material uniformly on the inner surface of the first mold, placing the matrix on the second raw material, preparing and forming a blank of the implant, wherein a surface of the blank comprises the shaping substance;
(step 4): removing the shaping substance of the blank of the implant and obtaining the implant.
